(19) United States
(12) Patent Application Publication
(10) Pub. No.: US 2021/0274989 A1
(43) Pub. Date: Sep. 9, 2021

(54) PARTICLE COLLECTION CONTAINER, STACK, AND METHOD

(71) Applicant: FESTOOL GMBH, Wendlingen (DE)

(72) Inventor: Gerhard GREBING, Nurtingen (DE)

(73) Assignee: FESTOOL GMBH, Wendlingen (DE)

(21) Appl. No.: 16/603,369

(22) PCT Filed: Apr. 10, 2018
(86) PCT No.: PCT/EP2018/059162

§ 371 Date: Oct. 7, 2019

(30) Foreign Application Priority Data
Apr. 11, 2017 (DE) 102017206220.7
Apr. 11, 2017 (DE) 102017206222.3
Apr. 11, 2017 (EP) PCT/EP2017/058690
Apr. 11, 2017 (EP) PCT/EP2017/058692
Apr. 11, 2017 (EP) PCT/EP2017/058693

(51) Int. Cl. A47L 9/16; B65D 71/00; B65D 21/02; B65D 25/28; A47L 7/00; B04C 11/00

(52) U.S. Cl. CPC A47L 9/1683; B65D 71/0088; B65D 21/0219; B04C 11/00; B65D 25/282; A47L 9/1691; A47L 7/0095; B65D 21/0233

(57) ABSTRACT

A particle collection container that is designed as a stand structure for a cyclonic pre-separator, can be positioned on a flat underlying surface in a stable manner, and has an open upper face on which the cyclonic pre-separator can be placed, includes a rectangular container base and four container peripheral walls which extend upwards from the container base and define a horizontal outer contour of the particle collection container. The horizontal outer contour defined by the container peripheral walls tapers towards the container base, and the particle collection container can be stacked into an identical particle collection container.

The invention relates to a particle collecting container that is designed as a stand structure for a cyclone pre-separator, can be positioned on a flat underlying surface in a stable manner, and has an open upper side, on which the cyclone pre-separator can be placed, comprising a rectangular container bottom and four container peripheral walls, which extend upwards from the container bottom and define a horizontal outer contour of the particle collecting container.

Said particle collecting container is typically operated together with the cyclone pre-separator as a separating preliminary stage of a suction apparatus. The cyclone pre-separator is positioned on the particle collecting container and connected to the suction apparatus, so that the airflow sucked in by the suction apparatus first passes through the cyclone pre-separator and then the suction unit. The cyclone pre-separator eliminates a majority of the particles contained in the airflow and outputs them into the particle collecting container where the particles are collected. Consequently, fewer particles are transported to the suction apparatus. This is a particular advantage if the suction apparatus has a bag and/or filter, at which particles are separated and which has to be changed when a particular fill level/degree of soiling is reached.

The particle collecting container is designed as a stand structure for the cyclone pre-separator—i.e. it serves as a support for the cyclone pre-separator. In particular the particle collecting container is designed to be placed in a stable manner on a flat underlying surface with the cyclone pre-separator positioned on the particle collecting container.

The particle collecting container described is in particular used in the manual crafts sector, where it is operated together with a cyclone pre-separator as a separating preliminary stage of the bag suction apparatuses commonly used there.

By way of example, the company “Oneida AirSystems” offers a set comprising a particle collecting container and a cyclone pre-separator under the product name “Ultimate Dust Deputy”. The particle collecting container has a substantially cuboid basic design. On the upper side of the particle collecting container a cover can be positioned, on which, in turn, a conical cyclone pre-separator can be placed. The particle collecting container is intended to accept a plastic bag in which the particles separated by the cyclone pre-separator are collected.

The object of the invention is to improve said particle collecting container such that it is easier and more efficient to use. This object is achieved by the features indicated in the characterising portion of claim 1. According to the invention, the particle collecting container is designed such that the horizontal outer contour defined by the container peripheral walls tapers towards the container bottom and the particle collecting container can be stacked into an identical particle collecting container.

Due to the fact that the particle collecting container is designed to taper downwards and can be stacked into an identical particle collecting container, a plurality of particle collecting containers can be transported in a stack in a very space-efficient manner. It is therefore possible, in a space-efficient manner, to bring along a plurality of particle collecting containers so that the particle collecting containers provide sufficient collection volume overall to collect the particles to be disposed of. The abovementioned plastic bag used in the prior art can then be dispensed with and the separated particles can be collected directly in the particle collecting containers. The assembly according to the invention can therefore be used more simply and efficiently.

The feature that the particle collecting container can be stacked into an identical particle collecting container means that the particle collecting container can be inserted with at least 50%, in particular at least 70%, of its vertical dimensions or vertical extension in an identically constructed particle collecting container. This feature further means in particular that at least three identical particle collecting containers can be inter-stacked such that they can together form a stable, vertical stack.

The feature that the container peripheral walls define a horizontal outer contour means in particular that the container peripheral walls provide the lateral outer walling of the particle collecting container and thus determine the outer contour of the particle collecting container.

The described form of the particle collecting container—namely that the horizontal outer contour defined by the container peripheral walls tapers downwards—is also referred to in the following as “conical”. In particular the horizontal outer contour tapers continuously and/or as far as the container bottom and/or over the entire vertical extension of the particle collecting container.

Advantageous embodiments are the subject matter of the dependent claims.

Preferably the wall planes of the four container peripheral walls are inclined away from the normal vector of the container bottom. Expediently the container peripheral walls together make the shape of an inverted truncated pyramid periphery. Consequently all four container peripheral walls contribute to the downward-tapering horizontal outer contour.

Preferably the particle collecting container has container couplers. The container couplers are in particular non-movable container couplers. The container couplers are arranged on two opposing container peripheral walls, in particular on two longitudinal container peripheral walls. The container couplers engage with lower housing couplers of the cyclone pre-separator, in order to provide a releasable, vertically tension-proof coupling between the particle collecting container and the cyclone pre-separator. Due to the fact that the container couplers are non-movable couplers, the particle collecting container can be manufactured very simply and cheaply.

The expression “releasable coupling” is intended in particular to designate a coupling that can be reversibly created and released without tools, by way of example a coupling involving a manually operable rotary latch or a manually operable locking lug. The expression “vertically tension-proof coupling” is intended in particular to mean a coupling which transmits force vertically and which expediently remains stable in the presence of the vertical forces acting during use or transport of the cyclone pre-separator. In the context of the cyclone pre-separator and the particle collecting container “vertically tension-proof coupling” is intended in particular to mean a coupling which, through lifting of the cyclone pre-separator allows a particle collecting container coupled in a vertically tension-proof manner to be lifted with the cyclone pre-separator. Expediently a “vertically tension-proof coupling” is a coupling, which in a plurality of, preferably in all, spatial directions, is tension-proof or remains stable during transfer of force.

Preferably the container peripheral walls have an upper edge. Expediently on the upper edge a surrounding seal is arranged. The seal allows an airtight coupling to be obtained between the cyclone pre-separator and the particle collecting container, whereby the suction performance can be improved in operation.

Preferably on two opposing peripheral walls, in particular two frontal peripheral walls, the particle collecting container has container handles. By means of the container handles, the particle collecting container is particularly easily portable.

Preferably the container handles are designed as spacers which when the particle collecting container is stacked in an identical particle collecting container, ensure a specified vertical distance between the two upper sides of the inter-stacked particle collecting containers. The result is that inter-stacked particle collecting containers can be easily removed or separated from one another.

Preferably the container handles have horizontal bars and vertical bars. Expediently the container handles are designed so that when the particle collecting container is stacked in an identical particle collecting container, lower edges of the vertical bars rest on the upper side of the identical particle collecting containers thereby ensuring the specified vertical distance. Such container handles are simple and cheap to manufacture.

Preferably the assembly comprises a bow-shaped carrying handle which, when the cyclone pre-separator is removed from the particle collecting container, can be attached to the container handles. Using such a bow-shaped carrying handle the particle collecting container can be carried with one hand.

Preferably the particle collecting container has two carrying indentations on the underside of the container bottom. In particular when the particle collecting container, due to its fill level, is especially heavy, the particle collecting container may have to be carried by its container bottom. In the embodiment described with carrying indentations the carrying person can grip the carrying indentation with their fingers to allow a better hold on the particle collecting container.

Preferably the assembly has a container cover positioned on the open upper side. Expediently on the upper side of the container cover an indentation is provided which is designed to correspond with the container bottom of the particle collecting container, so that an identical particle collecting container can be stacked on the container cover in a stable manner. If, as mentioned above, a plurality of particle collecting containers are used, then when full these can be closed with the cover container and stacked by means of the indentation provided in the cover in a stable manner one on top of the other ready for transport or storage.

Preferably the container cover has a length of between 390 mm and 400 mm, in particular the container cover has a width of between 290 mm and 300 mm. With such dimensioning of the container cover, eight particle collecting containers with container covers can be arranged on one Europool pallet in an extremely space-efficient manner.

Preferably the particle collecting container is produced by injection moulding. Production by injection moulding is in particular enabled by the conical design of the particle collecting container described above. Production by injection moulding makes the particle collecting container cheaper to produce and its design can be less bulky making it easier to carry.

The invention also relates to a stack comprising a particle collecting container according to any one of the embodiments discussed above and to an additional particle collecting container with an identical design to the particle collecting container, in which the particle collecting container is stacked. In the stacked state the particle collecting containers can be transported easily and in a space-efficient manner to their point of use.

The invention also relates to an assembly comprising a transport pallet, in particular a Europool pallet. The assembly comprises preferably sixteen particle collecting containers arranged on the transport pallet. Expediently the particle collecting containers are distributed over two stack levels. Each stack level expediently has two rows of four particle collecting containers each. Each stack level expediently uses more than 90%, in particular more than 95% of the base area of the transport pallet. In the assembly described, the particle collecting containers can be transported in a space-efficient manner.

The invention also relates to a method for disposing of particles that can be sucked up, in particular dust particles. The invention comprises in particular the step of sucking up the particles using a cyclone separator, in particular a cyclone pre-separator, into a particle collecting container. The particle collecting container is expediently designed according to one of the embodiments discussed above. The method preferably also comprises the step of closing the particle collecting container. Expediently the method also comprises the step of taking the particles to their final disposal, in particular waste incineration, final storage and/or recycling, in the particle collecting container. As a result, the particles remain in the particle collecting container until final disposal or until they are transported to the final disposal facility. Consequently in one step the particles are sucked into the particle collecting container and then remain there until they are disposed of or taken to their disposal location. Consequently transfer processes and the associated contamination can be avoided.

The invention also relates to a method for sucking up dust particles. The invention comprises preferably the step of sucking up particles into a particle collecting container using a cyclone separator, in particular a cyclone pre-separator, positioned on the particle collecting container. The particle collecting container is expediently a particle collecting container described above. The method comprises in particular the steps of removing the cyclone separator from the particle collecting container, placing the cyclone separator on an additional particle collecting container and sucking up particles into the additional particle collecting container using the cyclone separator. Consequently, the additional particle collecting container is used as a swap container—as soon as the particle collecting container is full, it can be replaced by the additional particle collecting container. The sucked-up particles are thus gathered up into a plurality of particle collecting containers and the plastic bag used in the prior art for receiving or collecting the sucked-up particles can be dispensed with.

Exemplary embodiments are described below by reference to the drawing.

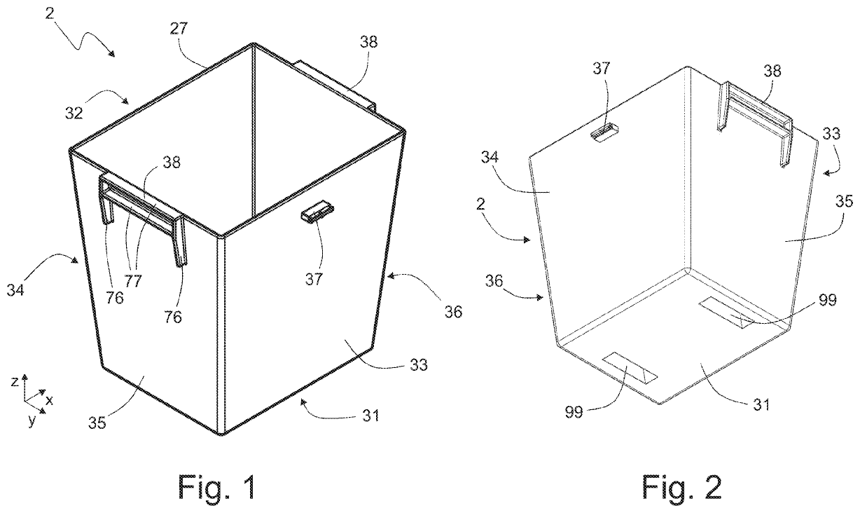

FIG. 1 shows a particle collecting container from above;

FIG. 2 shows a particle collecting container from below;

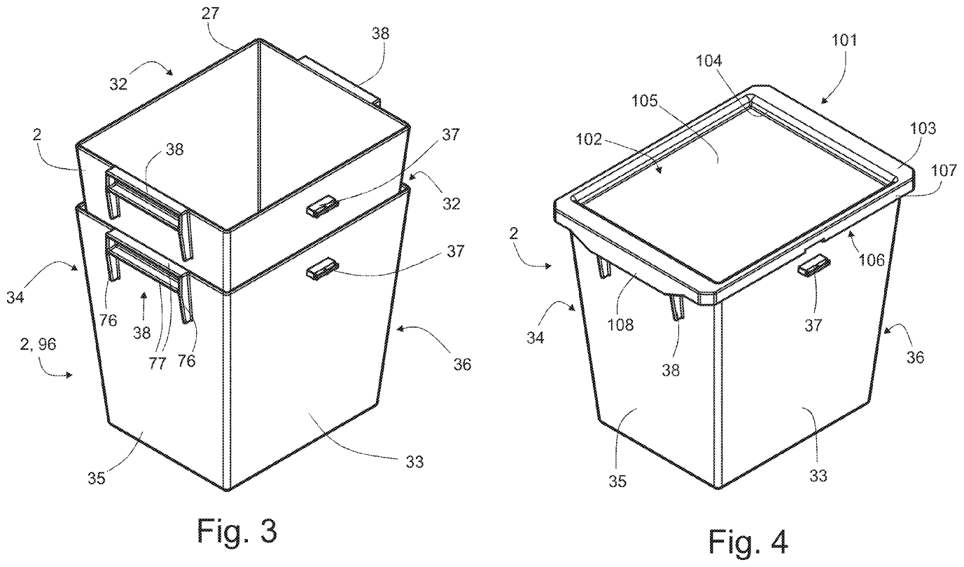

FIG. 3 shows a stack of two particle collecting containers;

FIG. 4 shows a particle collecting container with put on container cover;

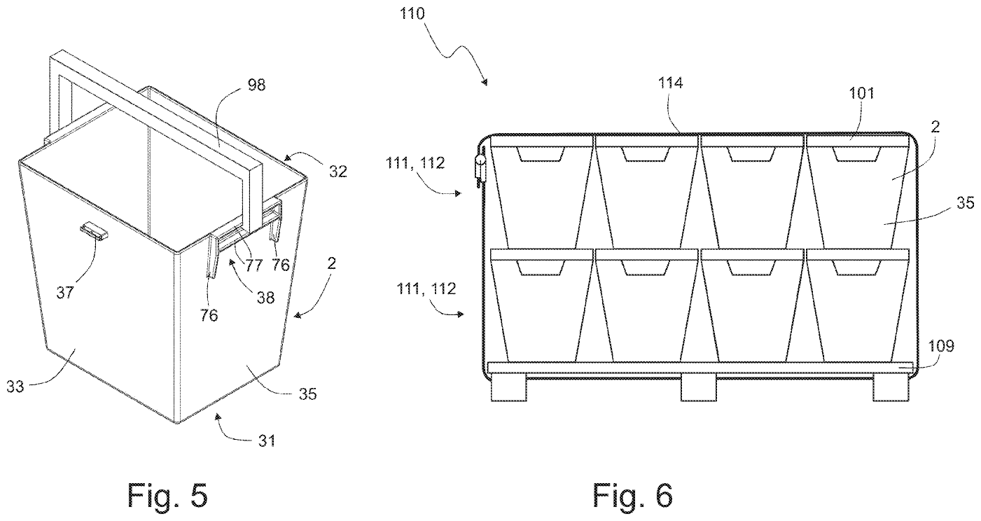

FIG. 5 shows a particle collecting container with a bow-shaped carrying handle;

FIG. 6 shows an assembly of a transport pallet with a plurality of particle collecting containers;

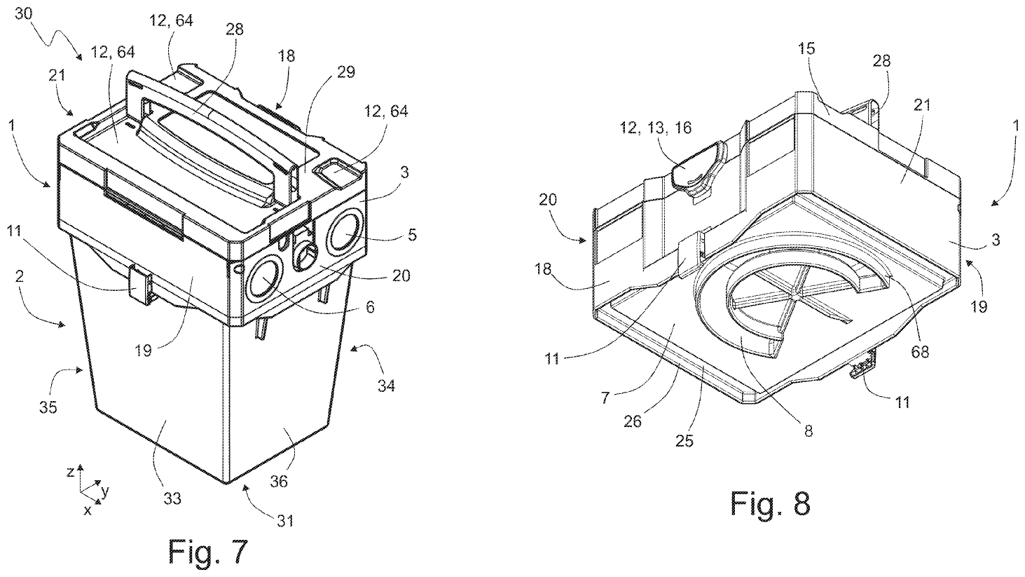

FIG. 7 shows an assembly of a particle collecting container and a cyclone separator positioned on the particle collecting container;

FIG. 8 shows a cyclone pre-separator from below;

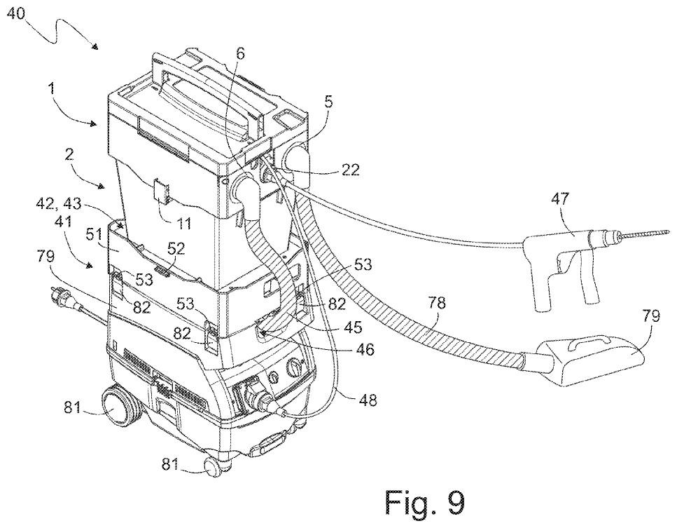

FIG. 9 shows an assembly of a cyclone pre-separator, a particle collecting container and a suction device;

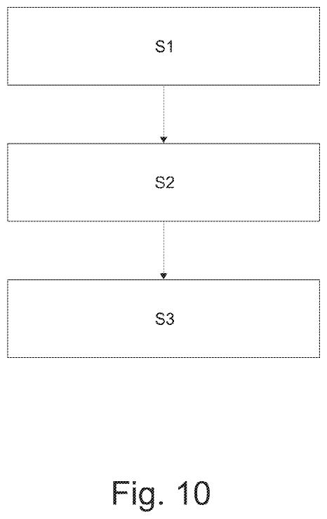

FIG. 10 shows a flow diagram of a method for disposal of particles;

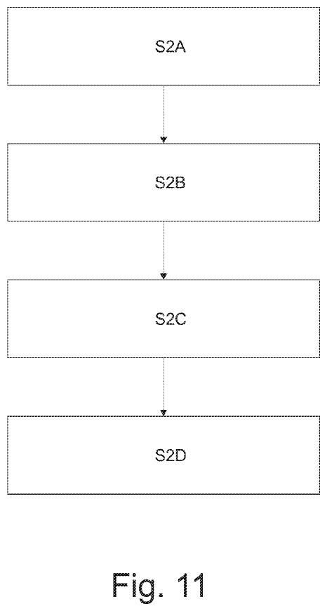

FIG. 11 shows a flow diagram of a method for sucking up particles;

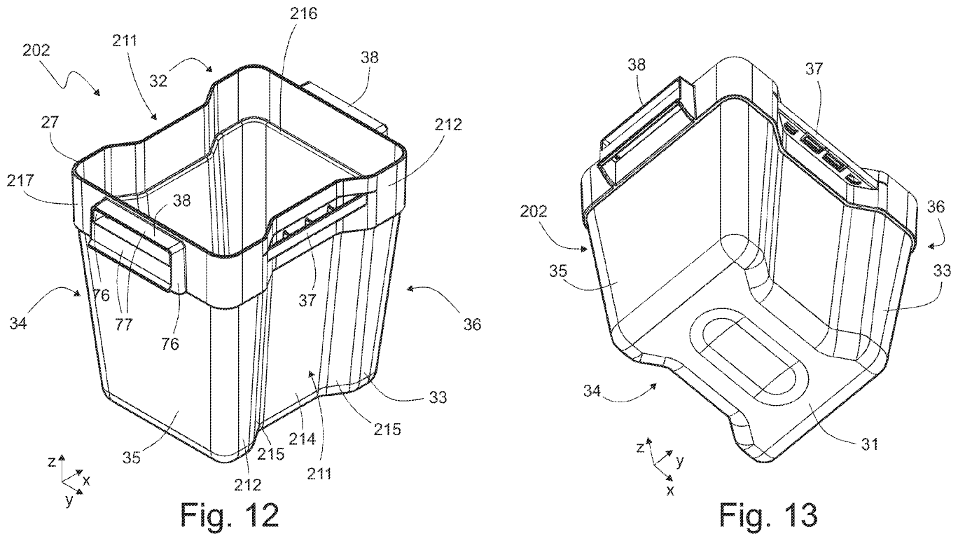

FIG. 12 shows a further particle collecting container from above;

FIG. 13 shows the further particle collecting container from below;

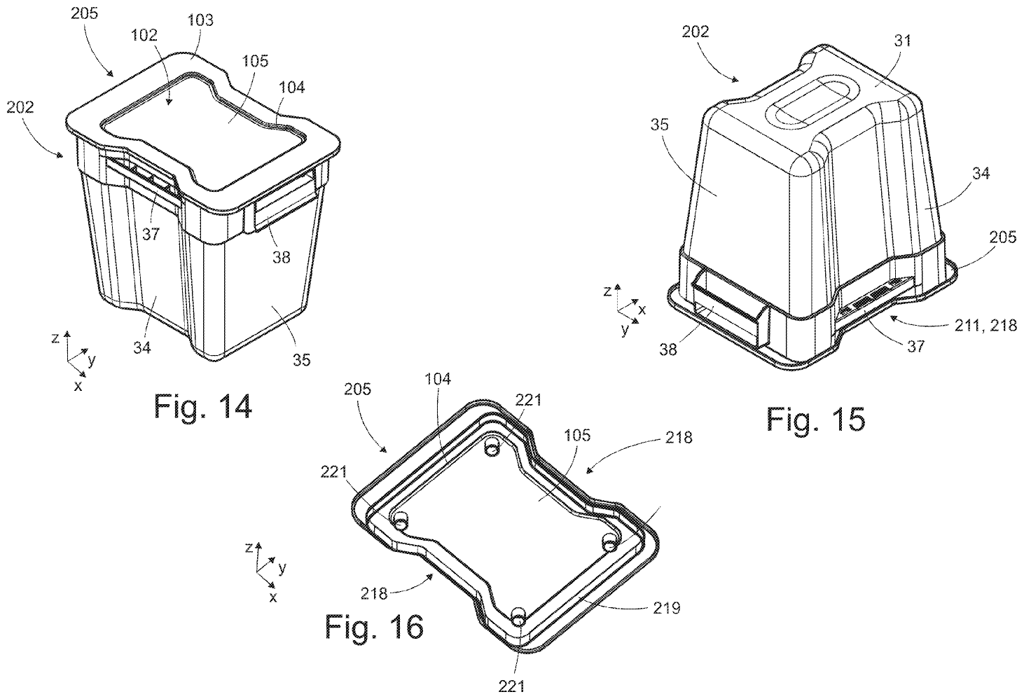

FIG. 14 the further particle collecting container with a put on container cover from above;

FIG. 15 shows the additional particle collecting container with a put on container cover from below;

FIG. 16 shows the container cover from below;

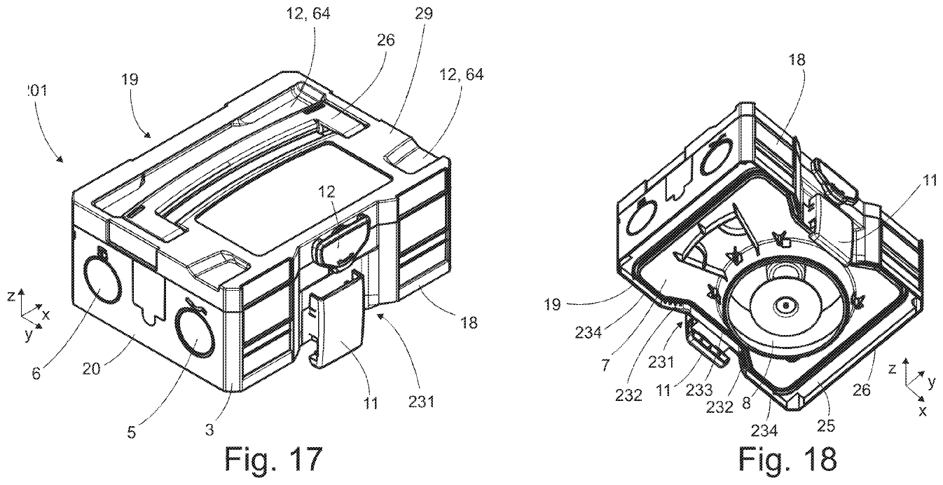

FIG. 17 shows a further cyclone pre-separator from above;

FIG. 18 shows a further cyclone pre-separator from below;

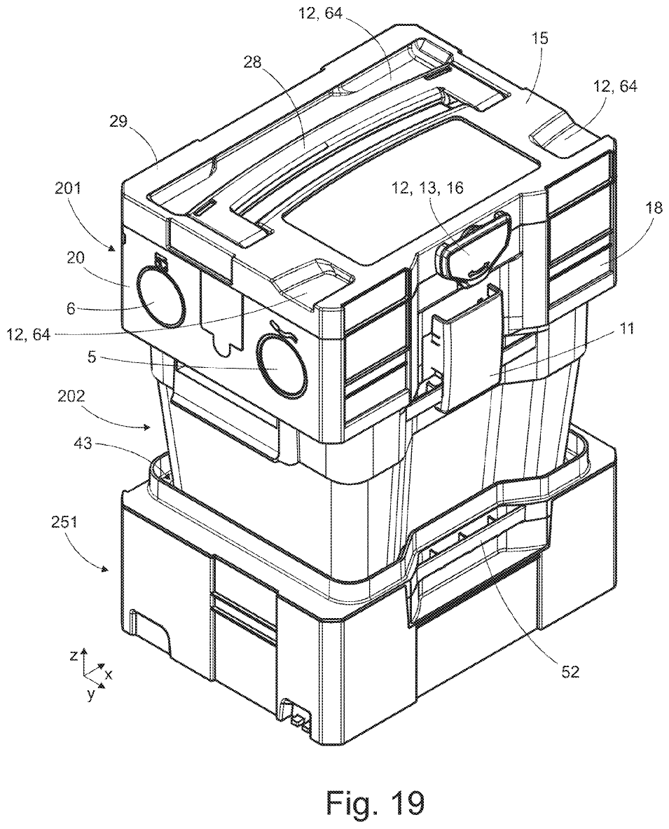

FIG. 19 shows an assembly of the further cyclone pre-separator, the further particle collecting container and a further adapter frame;

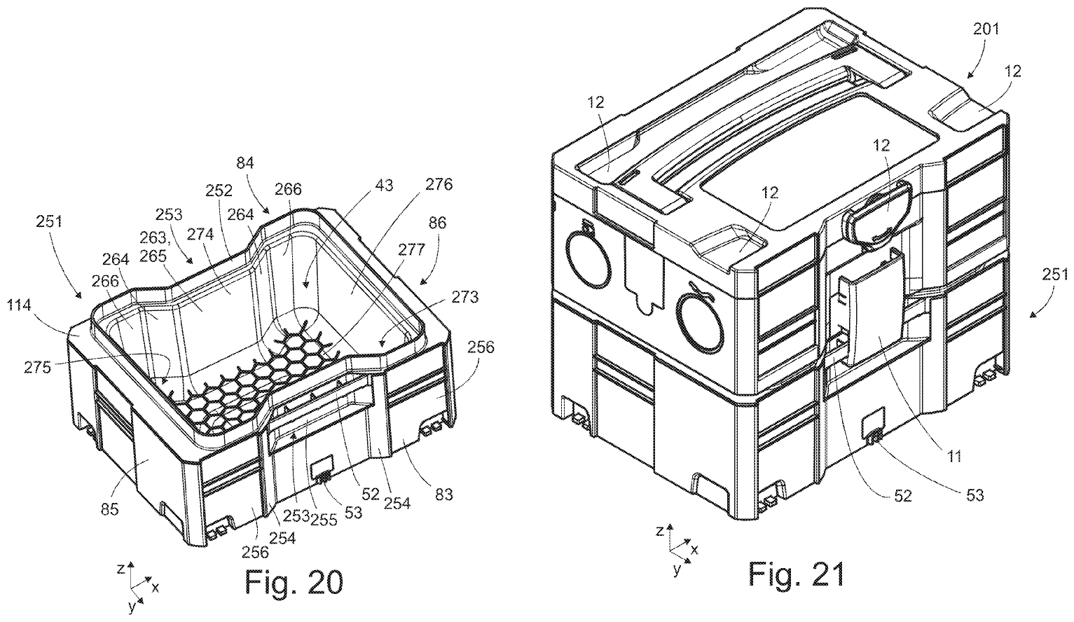

FIG. 20 shows the further adapter frame from above; and

FIG. 21 shows an assembly of the further adapter frame and the further cyclone pre-separator.

As shown in FIG. 1, the particle collecting container 2 extends in a vertical direction, running parallel to the indicated z-axis, in a longitudinal direction, running parallel to the indicated x-axis, and in a transverse direction, running parallel to the indicated y-axis. The x-axis, y-axis and z-axis are aligned orthogonally to each other.

The particle collecting container 2 is designed as a stand structure for a cyclone pre-separator 1. FIG. 7 shows, by way of example, how the particle collecting container 2 carries the cyclone separator 1. The particle collecting container 2 can be placed on a flat underlying surface. The particle collecting container 2 further has an open upper side 32, on which the cyclone pre-separator 1 can be positioned. The particle collecting container 2 has a rectangular container bottom 31 and four container peripheral walls 33, 34,35, 36, extending upwards from the container bottom 31 and defining a horizontal outer contour of the particle collecting container 2. The horizontal outer contour defined by the container peripheral walls 33, 34, 35, 36 tapers towards the container bottom 31. The particle collecting container 2 can be stacked in an identical particle collecting container 2.

The particle collecting container 2 can thus be transported and stowed in a stack with other particle collecting containers 2 of the same design and is consequently easier and more efficient to use.

In the following exemplary configurations of the particle collecting container 1, the assemblies 30, 40, 120 are discussed, as well as their components.

As shown in FIG. 1, the upper side 32 of the particle collecting container 2 is completely open; i.e. the upper side 32 is formed by the upper edge 27 of the container peripheral walls 33, 34, 35, 36. The height of the particle collecting container 2 is exemplarily greater than its length and greater than its width. Expediently the width of the particle collecting container 2 is less than its length. Exemplarily the particle collecting container 2 has a height of 300 mm to 400 mm, preferably a height of 350 mm. The length of the particle collecting container 2 on its upper side is expediently 300 mm to 380 mm, preferably 343 mm. On its underside the length of the particle collecting container is expediently 230 mm to 330 mm, preferably 283 mm. The width of the particle collecting container 2 on its upper side is expediently 230 mm to 290 mm, preferably 283 mm. On its underside the width of the particle collecting container 2 is expediently 180 mm to 260 mm, preferably 223 mm.

The particle collecting container 2, and in particular the container bottom 31, are designed such that the particle collecting container 2 can be placed with the container bottom 31 on a flat underlying surface in a stable manner, in particular also when the cyclone pre-separator 1 is positioned on the particle collecting container 2.

The container peripheral walls 33 and 34 are aligned parallel to the longitudinal direction and are also referred to as longitudinal container peripheral walls 33, 34. The container peripheral walls 35 and 36 are aligned parallel to the transverse direction and are also referred to as frontal peripheral walls 35, 36.

Exemplarily the wall planes of the four container peripheral walls 33, 34, 35, 36 are inclined away from the normal vector of the container bottom 31. Expediently the container peripheral walls 33, 34, 35, 36 together make the shape of an inverted truncated pyramid periphery. Consequently all four container peripheral walls 33, 34, 35, 36 contribute to the downward-tapering horizontal outer contour.

Exemplarily the particle collecting container 2 has container couplers 37. The container couplers 37 are in particular non-movable container couplers. The container couplers 37 are arranged on two opposing container peripheral walls 33, 34, in particular on the two longitudinal container peripheral walls 33, 34. The container couplers 37 can engage with lower housing couplers 11 of the cyclone pre-separator 1, in order to provide the releasable, vertically tension-proof coupling between the particle collecting container 2 and the cyclone pre-separator 1.

The container couplers 37 are expediently bar-shaped protrusions, in particular precisely two bar-shaped protrusions. Exemplarily the bar-shaped protrusions are respectively between 20 mm and 50 mm, preferably 35 mm, long. The container couplers 37 are preferably aligned with their longitudinal axis parallel to the longitudinal direction and in the longitudinal direction in particular centrally arranged on the longitudinal container peripheral walls 33, 34. The container couplers 37 are also expediently located in the region of the upper side 32 of the particle collecting container 2. Exemplarily the container couplers 37 are vertically spaced apart from the upper side 32. Exemplarily the container couplers 37 are spaced apart in the vertical direction 20 mm to 60 mm, preferably 40 mm, from the upper side 32. The container couplers 37 designed as bar-shaped projections can also be referred to as functional edges.

Exemplarily, the particle collecting container 2 also has on two opposing container peripheral walls 35, 36, in particular two frontal container peripheral walls 35, 36, container handles 38. The container handles can be gripped to lift and carry the particle collecting container 2. The container handles 38 are arranged in the region of the upper side 32. Exemplarily the container handles 38 close flush with the upper side 32.

Exemplarily the container handles 38 each have two horizontal bars 77 and two vertical bars 76. Preferably the container handles 38 each have precisely one or precisely two horizontal bars 77 and precisely two vertical bars 76. The vertical bars 76 are arranged between the horizontal bars 77 spaced apart from each other. The upper horizontal bars 77 closes exemplarily flush with the upper side 32 of the particle collecting container 2, but may also be spaced apart from this.

Optionally on the upper edge 27 a surrounding seal is arranged. The seal is in particular made from elastic material and can by way of example be injection-moulded onto the container peripheral walls 33, 34, 35, 36.

The wall surfaces of the container peripheral walls 33, 34, 35, 36 exemplarily have a substantially flat design. Preferably the wall surfaces of the container peripheral walls 33, 34, 35, 36 with the exception of the couplers 37 and the container handles 38 have a substantially flat design. On the flat design wall surfaces one or more masking labels can by way of example be applied. Expediently the particle collecting container 2 can also have a pocket, by way of example in one of the container peripheral walls 33, 34, 35, 36, designed for receiving and/or securing a tracking device. The tracking device may, by way of example, be a Bluetooth and/or a GPS module. Expediently the tracking device is arranged in the pocket.

FIG. 2 shows the particle collecting container 2 from below. Here the particle collecting container 2 is equipped on its container bottom 31 with two carrying indentations 99. The carrying indentations 99 are in particular arranged in the region of the frontal peripheral walls 35, 36. The carrying indentations 99 are in particular designed so that a person carrying the particle collecting container 2 can grip the carrying indentations with their fingers 99.

FIG. 3 shows the particle collecting container 2, as stacked in an identical particle collecting container 2. The identical particle collecting container 2 is also referred to as an additional particle collecting container 96.

The abovementioned container handles 38 are exemplarily designed as spacers which, when the particle collecting container 2 is stacked in the identical particle collecting container 2, ensure a specified vertical distance between the two upper sides 32 of the inter-stacked particle collecting containers 2. Expediently the container handles 38 are designed so that the lower edges of the vertical bars 76 of the upper particle collecting container 2 rest on the upper side 32 of lower particle collecting container 2 thereby ensuring the specified vertical distance. In FIG. 2, the lower edges of the vertical bars 76 of the upper particle collecting container 2 are not yet resting on the upper side 32 of lower particle collecting container 2 so that here the upper particle collecting container 2 can still be pushed further into the lower particle collecting container 2.

The particle collecting container 2 and the additional particle collecting container 96 are exemplarily produced by injection moulding. In particular the particle collecting container is produced with the container couplers 37 and/or the container handles 38 as one piece by injection moulding.

FIG. 4 shows the particle collecting container 2 with a container cover 101 positioned on the open upper side 32. The container cover 101 fully closes the particle collecting container 2. Exemplarily on the cover upper side 103 of the container cover 101 a cover indentation 102 is provided. Expediently the cover indentation 102 is designed to correspond with the container bottom 31 of the particle collecting container 2, so that an identical particle collecting container 2 can be stacked on the container cover 101 in a stable manner.

The indentation bottom 105 of the cover indentation 102 exemplarily has a rectangular design and is connected via an indentation side wall 104 extending upwards from the indentation base with the cover upper side 103. From the cover upper side 103 a surrounding cover side wall 107 extends downwards. Between the indentation side wall 104 and the cover side wall 107 there is a cover groove 106 which serves to accept the upper edge 27 of the particle collecting container 2. In the cover groove 106 preferably a surrounding seal is provided which in particular is made from elastic material. Expediently the horizontal inner contour defined by the indentation side wall 104 tapers downwards to the indentation bottom 105. The cover indentation 102 is in particular designed so that a particle collecting container 2 can be positioned in a stable manner in the cover indentation 102 and is surrounded by and preferably also stabilized by the indentation side wall 104.

The cover side wall 107 is in particular designed so that it ac least partially covers the holder handles 38 and thus protects them. To this end the cover side wall 107 has respective frontal wall portions 108 protruding downwards. The cover side wall 107 is further expediently designed so that the longitudinal peripheral walls 33, 34 of the particle collecting container 2 and by way of example marking labels applied there are in particular protected from the effects of weather.

The container cover 101 can also have longitudinal lashing indentations on the cover upper side 103 which are not shown in FIG. 3. The lashing indentations can be arranged centrally in the longitudinal direction—and thus in the longitudinal direction be located in the region of the container couplers 37. Expediently the lashing indentations are designed to hold or guide a lashing belt running transversally across the container cover.

Preferably the particle collecting container 2 is located fully within the outer contour defined by the container cover 101; i.e. the maximum dimensions of the particle collecting container 2 in the longitudinal direction are the same as or smaller than the corresponding maximum dimensions of the container cover 101.

FIG. 5 shows the particle collecting container 2 with a bow-shaped carrying handle 98. The carrying handle 98 has in particular an inverted U shape. The carrying handle 98 is exemplarily mounted on the holder handles 38, in particular on the horizontal bars 77. Preferably the carrying handle 98 is mounted using a snap- or clamp-fastening to the container handles 38, so that in particular it can be removed from the container handles 38 or remounted on these without tools. The carrying handle 38 runs in the longitudinal direction across the open upper side 32 of the particle collecting container 2.

FIG. 6 shows an assembly 110, comprising a transport pallet 109, in particular a Europool pallet, and a plurality of particle collecting containers 2 arranged thereon. Preferably sixteen particle collecting containers 2 are arranged on the transport pallet 109. The particle collecting containers 2 are distributed over two stack levels 111. The two stack levels 111 are stacked one on top of the other. Each stack level 111 exemplarily has two rows 112 of four particle collecting containers 2 each. The rows 112 of each stack level 111 are arranged alongside each other. In FIG. 6 only one row 112 of each stack level 111 is shown. Exemplarily the particle collecting containers are arranged with their frontal peripheral walls 35, 36 parallel to the row-direction of the rows 112.

Preferably each stack level 111 uses more than 90%, in particular more than 95% of the base area of the transport pallet. The particle collecting containers 2 are each closed by a container cover 101. The horizontal area taken up by a stack level 111 is therefore given by the sum of the horizontal areas taken up by the container covers 101.

Exemplarily, every two rows 112 stacked on top of each other are lashed together and to the transport pallet 109 using a lashing belt 114. Preferably the lashing belt is guided through the abovementioned lashing belt indentations.

Preferably the horizontal external dimensions or the maximum horizontal outer contour of the container cover 101 correspond to the horizontal external dimensions of the upper side 29 of the cyclone pre-separator 1 explained in more detail in the following. Thus, it is possible for a stack that contains the cyclone pre-separator 1 to be transported in a space-efficient manner together with particle collecting containers 2, in particular on the transport pallet 109.

FIG. 7 shows the assembly 30 with the cyclone pre-separator 1 positioned on the particle collecting container 2 and connected by means of lower housing couplers 11 in a vertically tension-proof manner with the particle collecting container 2. The cyclone pre-separator 1 is positioned with its underside 7 or a groove 25 arranged on the underside 7 on the particle collecting container 2. The horizontal outer contour of the upper side 32 of the particle collecting container 2 is positioned within the horizontal outer contour of the underside 7 of the cyclone pre-separator 1; i.e. the cyclone pre-separator 1 protrudes in all horizontal directions beyond the container peripheral walls 33, 34, 35, 36. The vertical extension of the particle collecting container 2 is greater than the vertical extension of the cyclone pre-separator 1. Preferably the particle collecting container 2 is double the height or more than double the height of the cyclone pre-separator 1.

The cyclone pre-separator 1 comprises a box-shaped housing 3. The term “box-shaped” in particular means a substantially cuboid design. “Box-shaped” also means a form where the upper side is designed so that a further box-shaped or cuboid body, in particular a system box, can be stacked on the upper side. By way of example, “box-shaped” means a form where the upper side and peripheral walls are aligned orthogonally to each other.

Thanks to its box-shaped design, the cyclone pre-separator can be accommodated and transported in a stack of further box-shaped bodies, such as by way of example system boxes.

System boxes of a system have a base area defined in the system and have couplers defined in the system or are compatible with a particular coupling system, so that system boxes of a system can be combined to form a stable stack. System boxes are, by way of example, widely used as modular toolboxes for the storage of manually-operated power tools, accessories and/or consumables.

The height of the cyclone pre-separator 1 is exemplarily less than its width and less than its length. Expediently the width of the cyclone pre-separator 1 is less than its length. By way of example, the cyclone pre-separator 1 is between 390 mm and 400 mm, in particular 396 mm, long and between 290 mm and 300 mm, in particular 296 mm, wide. Preferably the height of the cyclone pre-separator 1 with folded carrying handle 28 is less than 200 mm.

The housing 3 of the cyclone pre-separator 1 has four peripheral walls 18, 19, 20, 21 aligned orthogonally to each other. The peripheral walls 18, 19 are longitudinal peripheral walls and the peripheral walls 20, 21 are frontal peripheral walls.

The housing 3 has lower housing couplers 11. Exemplarily the lower housing couplers 11 comprise two movably mounted locking elements and are provided on longitudinal peripheral walls 18, 19 of the housing 3. Expediently the locking elements are arranged in the longitudinal direction centrally on the longitudinal peripheral walls 18, 19. The locking elements are in particular designed as locking lugs, mounted so that they can swivel and/or slide.

FIG. 8 shows the cyclone pre-separator 1 from below. On the underside 7 of the cyclone pre-separator 1 the particle outlet 8 is arranged, which exemplarily has an annular gap or annular section gap design. Expediently the particle outlet 8 is surrounded by an edge 68 protruding vertically downwards.

On the underside 7 a groove 25 is also provided, running along the outer edge 26 of the underside 7 and designed to accept the upper edge 27 of the particle collecting container 2. The groove 25 completely surrounds the particle outlet 8 and has an overall rectangular course. The outer edge 26 of the underside is exemplarily formed by the lower edge of the peripheral walls 18, 19, 20, 21.

The housing 3 comprises a cover 15, extending over the entire horizontal extension of the cyclone pre-separator 1. The cover 15 is hinged so that it can swivel. In the open position the swivelling cover 15 provides access to the internal components of the cyclone pre-separator 1, so that these can be cleaned and maintained.

A carrying handle 28 is provided on the cover 15. In the example shown, the carrying handle 28 is arranged on the upper side 29 of the cover 15. The carrying handle 28 is advantageously designed so that it can selectively adopt a non-use position, in which the carrying handle 28 is swivelled in against the upper side 29 of the cover 15, or a use position, in which the carrying handle 28 is swivelled out and consequently protrudes beyond the upper side 29. The carrying handle 28 is preferably U-shaped.

The cyclone pre-separator 1 has an air inlet 5 and an air outlet 6, which exemplarily are arranged on the same peripheral wall, in particular on the frontal peripheral wall 20.

The cyclone pre-separator 1 uses the known operating principle of a cyclone separator or of a centrifugal separator. When there is a negative pressure at the air outlet 6 an airflow is sucked in through the air inlet 5, passes through an inlet cylinder (not shown) and is output via the air outlet 6. The inlet cylinder is designed so that the airflow is directed on a circular path, wherein particles contained in the airflow are hurled against the walls of the inlet cylinder by the centrifugal force, so that they are braked and finally output from the particle outlet 8.

The housing 3 exemplarily has upper housing couplers 12, comprising a movably mounted locking element 13. The upper housing couplers 12 are designed to provide a releasable, vertically tension-proof coupling for a box-shaped body when the box-shaped body is stacked on the housing 3.

The movably mounted locking element 13 is exemplarily designed as a rotary latch 16. Expediently the locking element 13 is arranged on the longitudinal peripheral side 18, in particular on the cover 15. The rotary latch 16 is designed both to lock the cover 15 and to provide the coupling with a box-shaped body arranged on the cyclone pre-separator 1. The rotary latch 16 has in particular a T-shaped design.

Exemplarily the upper housing couplers 12 further have engagement structures 64, suitable for engaging with corresponding engagement structures such as by way of example feet of system box. The engagement structures 64 are provided on the upper side 29 and are expediently designed as engagement indentations. The engagement structures 64 are expediently static structures—thus non-movable structures. Expediently the engagement structures 64 are designed to contribute to a vertical and/or horizontal coupling. By way of example, the engagement structures 64 can have rear grip components for this.

FIG. 9 shows an assembly 40 of the cyclone pre-separator 1, particle collecting container 2 and a suction device 41. The cyclone pre-separator 1 is positioned on the particle collecting container 2 and through the lower housing couplers 11 and the container couplers 37 coupled in a vertically tension-proof manner to the particle collecting container 2. The particle collecting container 2 is in turn inserted in a container receptacle 43, provided on the upper side 42 of the suction device 41. The suction device 41 has a suction port 46 and is designed to provide a negative pressure at this suction port 46. The suction port 46 is connected via a hose 45 with the air outlet 6. A suction hose 78 with a suction head 79 is connected to the air inlet 5. The suction device 41 is expediently a bag suction device and/or a filter suction device.

If the suction device 41 is switched on and starts to suck, then via the suction head 79 and the suction hose 78 an airflow is sucked into the cyclone pre-separator 1. There, a part of the particles present in the airflow is separated and transported to the particle collecting container 2. The airflow is output through the air outlet 6 and via the hose 45 and the suction port 46 reaches the suction device 41. There, the airflow passes, by way of example, through a bag and/or a filter, where the particles still contained in the airflow at this point are separated. Due to the fact that a part of the particles has already been separated in the cyclone pre-separator 1, fewer particles reach the bag or filter, so that the bag or filter has to be changed less frequently.

The suction device 41 comprises exemplarily a suction apparatus 79 and an adapter frame 51 positioned on the suction apparatus 79. The container receptacle 43 is provided in the adapter frame 51.

The suction apparatus 79 is exemplarily designed as a mobile suction apparatus and has drive wheels 81, by which the suction apparatus 79 is movable.

The suction apparatus 79 has suction apparatus couplers 82, coupled to the lower adapter frame couplers 53. Exemplarily the suction apparatus couplers 82 comprise movably mounted locking lugs and the lower adapter frame couplers 53 comprise locking projections.

The assembly 40 shown in FIG. 7 further comprises an electrical device 47, by way of example a power tool, connected to a socket 22 of the cyclone pre-separator 1. The socket 22 is in turn connected via a connecting cable 48 to the suction apparatus 79. The suction apparatus 79 is exemplarily designed to detect that the power tool 47 has been switched on and, in response thereto, to start sucking.

The adapter frame 51 exemplarily further has upper adapter frame couplers 52, which provide a releasable, vertically tension-proof coupling with the cyclone pre-separator 1, in particular with the lower housing couplers 11 of the cyclone pre-separator 1 designed as locking lugs. The cyclone pre-separator 1 can thus be mounted directly on the adapter frame 51 for transport purposes. The adapter frame couplers 52 are in particular non-movable adapter frame couplers, expediently bar-shaped projections.

FIG. 10 shows a flow diagram of a method for disposing of particles, in particular dust particles. The particles to be disposed of are in particular those which arise in the manual crafts sector, by way of example when processing a workpiece. The particles to be disposed of may also be in particular rubble and/or construction waste. By way of example, particles from concrete, tiles, ceramic, mortar, plaster, stone and/or brick may be involved.

The method comprises a first step during which, using a cyclone separator, in particular a cyclone pre-separator 1, the particles are sucked up into the particle collecting container 2. This means in particular that the particles are sucked into the cyclone separator and output by the cyclone separator into the particle collecting container 2. The step S1 can by way of example be carried out by means of the assembly shown in FIG. 9.

The method further comprises a second step, in which the particle collecting container 2 is closed. Expediently the particle collecting container is closed by the container cover 101.

In a third step S3 the particles are then taken in the particle collecting container 2 to their final disposal. The final disposal involves in particular a process in which the particles, on the basis of a physical procedure and/or a chemical reaction, change the form and/or composition, and/or a storage state in which the particles remain permanently at a storage location. By way of example the final disposal involves waste incineration, recycling, or final storage, by way of example at a waste disposal site.

Taking the particles to final disposal means in particular the carriage of the particles to the location or the facility where final disposal takes place. By way of example this means that the particles are transported to the appropriate facility. This transport takes place in the particle collecting container 2, by way of example in the assembly 110 shown in FIG. 6.

During final disposal the particles can be removed from the particle collecting container 2. By way of example the particles can be removed from the particle collecting container 2 at an incineration facility prior to incineration, in a recycling facility prior to recycling, or at a waste disposal site prior to final storage. In particular the particles are removed from the particle collecting container 2 immediately prior to final disposal. The particle collecting container 2 can then be re-used.

Alternatively, the disposal of the particles can take place in the particle collecting container 2. By way of example the particles can be incinerated, recycled or disposed of together with the particle collecting container 2.

In the method described above, using the cyclone separator, in particular the cyclone pre-separator 1, the particles can further be sucked into a plurality of particle collecting containers 2 and then taken to the final disposal in the plurality of particle collecting containers 2.

Here by way of example the method shown in FIG. 11 may be applied. This method includes step S2A of sucking up particles into a particle collecting container 2 using a cyclone separator, in particular a cyclone pre-separator 1, positioned on the particle collecting container 2. The method further comprises step S2B of removing the cyclone separator 1 from the particle collecting container 2, step S2C of placing the cyclone separator 1 on an additional particle collecting container 96 and step S2D of sucking up particles into the additional particle collecting container 96 using the cyclone separator, in particular the cyclone pre-separator 1.

The abovementioned particle collecting container and/or the abovementioned additional particle collecting container can in particular be designed according to the particle collecting container 202 described below and shown in FIGS. 12 and 13. The abovementioned cyclone pre-separator can in particular be designed according to the cyclone pre-separator 201 described below and shown in FIGS. 17 and 18. In particular, the particle collecting container 202 and/or cyclone pre-separator 201 can be used in one of the abovementioned methods.

FIGS. 12 and 13 show a particle collecting container 202 that represents a preferred further development of the particle collecting container 2 explained above and shown in FIGS. 1 and 2.

The particle collecting container 202 is—apart from the differences described below—designed like the particle collecting container 2. The above descriptions relating to the particle collecting container 2 insofar also apply to the particle collecting container 202.

Like the particle collecting container 2 the particle collecting container 202 is designed as a stand structure for a cyclone pre-separator, can be positioned on a flat underlying surface in a stable manner and has an open upper side 32, on which the cyclone pre-separator can be positioned. The particle collecting container 202 has a rectangular container bottom 31 and four container peripheral walls 33, 34, 35, 36, extending upwards from the container bottom 31 and defining a horizontal outer contour of the particle collecting container 2. The horizontal outer contour defined by the container peripheral walls 33, 34, 35, 36 tapers towards the container bottom 31 and the particle collecting container 202 can be stacked in an identical particle collecting container 202.

Unlike the particle collecting container 2 the particle collecting container 202 has a recess 211 on each of its longitudinal container peripheral walls 33, 34.

Each recess 211 is expediently located in the longitudinal direction x centrally on the respective container peripheral wall 33, 34 and preferably runs in the transversal direction y towards the inside of the particle collecting container 202. In the longitudinal direction x each recess 211 expediently accounts for 40% or more, in particular 50% or more, of the x-extension of the respective longitudinal container peripheral wall 33, 34. In the transversal direction y each recess 211 expediently accounts for 5% or more, in particular 8% or more, of the y-extension of the particle collecting container.

Each recess 211 extends expediently over the entire vertical extension of the particle collecting container 202. Preferably each recess 211 runs from the upper edge 27 to the container bottom 31 and is in particular also present on the upper edge 27 and the container bottom 31.

The recesses 211 are exemplarily formed by the course of the longitudinal container peripheral walls 33, 34, so that the longitudinal container peripheral walls 33, 34 form corresponding projections in the inside of the particle collecting container 211.

Exemplarily each longitudinal container peripheral wall 33, 34 has two outer wall portions 212 and a central wall portion 214, arranged in the longitudinal direction x between the two outer wall portions 212. The central wall portion 214 is inwardly displaced in relation to the outer wall portions 212 in the y-direction thereby forming the recess 211. The transition from the outer wall portions 212 to the central wall portion 214 is formed by the transition portions 215 which are located in the longitudinal direction between the central wall portion 214 and each of the outer wall portions 212. The transition portions 215 run expediently in y-x-directions, in particular in directions which relative to the longitudinal direction are rotated about a vertical axis by ±20 to ±50 degrees, in particular ±30 to ±40 degrees. The outer wall portions 212 and/or the central wall portion 214 run exemplarily in the x direction.

One recess 211 is formed by a one central wall portion 214 and two transition wall portions 215. In the longitudinal direction x the central wall section 214 preferably accounts for 40% or more, in particular 50% or more, of the x-extension of the recess 211. Each transition wall portion 215 in the longitudinal direction x preferably accounts for 20% or more of the x-extension of the recess 211. The outer wall portions 212, the central wall portion 214 and/or the transition wall portions 215 extend expediently over the entire vertical extension of the particle collecting container 202.

On the transverse container peripheral walls 35, 36 expediently no recesses are present. Expediently the transversal container peripheral walls 35, 36 (apart from optional roundings in the corner regions) each have a straight course in the y-direction.

The particle collecting container 202 exemplarily has the container couplers 37 which are brought into engagement with lower housing couplers 11 of a cyclone pre-separator, in particular the cyclone pre-separator 201 described below, in order to provide a releasable, vertically tension-proof coupling between the particle collecting container 2 and the cyclone pre-separator 201.

The container couplers 37 are expediently arranged on the longitudinal container peripheral walls 33, 34, in particular in the recesses 211. Expediently, the container couplers 37 are located in the upper region of the particle collecting container 202, in particular in the upper fifth of the vertical extension of the particle collecting container 202.

The container couplers 37 are in particular non-movable container couplers. The container couplers 37 are expediently bar-shaped protrusions, in particular precisely two bar-shaped protrusions. Exemplarily the container couplers 37 account for 40% or more, in particular at least 50% or more, of the x-extension of the respective longitudinal container peripheral wall 33, 34. The container couplers 37 have a longitudinal basic shape and are preferably aligned with their longitudinal axis parallel to the longitudinal direction and in the longitudinal direction in particular centrally arranged on the longitudinal container peripheral walls 33, 34. Expediently the container couplers 37 each run from one transition wall portion 215 to another transition wall portion 215.

Exemplarily the particle collecting container 202 has a plurality of roundings. The transitions between the transversal container peripheral walls 35, 36 and the longitudinal container peripheral walls 33, 34 are rounded, the transitions between the container peripheral walls 33, 34, 35, 36 and the container bottom 31 are rounded, the transitions between the outer wall portions 212 and the transition wall portions 215 are rounded and the transitions between the transition wall portions 215 and the central wall portions 214 are rounded.

The particle collecting container 202 exemplarily has a horizontal step 216, via which the upper region 217 of the container peripheral walls 33, 34, 35, 36 is displaced horizontally outwards in relation to the other region. The horizontal step 216 surrounds the particle collecting container 202 completely; i.e. it is present on all container peripheral walls 33, 34, 35, 36. The upper region 217 defined by the horizontal step 216 accounts for preferably 20% to 25% of the vertical extension of the particle collecting container 202. Expediently the container couplers 37 and/or the container handles 38 are located in the upper region 217. The horizontal step 216 can by way of example serve as a fill mark. Expediently the internal volume of the particle collecting container 202 up to the horizontal step 216 is at least 18 litres.

Expediently on the particle collecting container 202, in particular on a transversal or longitudinal container peripheral wall 33, 34, 35, 36 a QR code can be arranged.

The container peripheral walls 33, 34, 35, 36 preferably have a thickness of 3.5 mm or more. The container bottom 31 is expediently vaulted and in particular designed to withstand a negative pressure of 260 mbar.

FIG. 16 shows a container cover 205 which, as shown in FIGS. 14 and 15, can be positioned on the upper side 32 of the particle collecting container 202, in order to close the upper side 32. The container cover 205 represents a further development on the container cover 101 described above. Expediently the above descriptions of the container cover 101 also apply to the container cover 205.

The container cover 205 has a rectangular shape and has cover recesses 218 on its longitudinal sides. The cover recesses 218 are designed to correspond to the container recesses 211, so that they are flush with these, when the container cover 205 is positioned on the particle collecting container 202, as shown in FIG. 15. The cover recesses 218 can by way of example serve as the abovementioned lashing indentations.

Exemplarily the longitudinal extension of the container cover 205 is greater than the longitudinal extension of the longitudinal container peripheral walls 33, 34, so that the container cover 205 in the longitudinal direction x protrudes beyond the frontal container peripheral walls 35, 36 and expediently covers the container handles 38.

On its upper side 103 the container cover 205 expediently has a cover indentation 102, designed to correspond with the container bottom 31 of the particle collecting container 202, so that an identical particle collecting container 202 can be stacked on the container cover 205 in a stable manner. The indentation bottom 105 of the cover indentation is connected via an indentation side wall 104 extending upwards from the indentation base 105 with the cover upper side 103. The indentation side wall 104 runs in correspondence with the horizontal outer contour of the container cover 218 and expediently likewise has recesses on its longitudinal sides.

On the underside of the container cover 205 a strip 219 is arranged, the course of which corresponds to the course of the upper edge 27 of the particle collecting container 202. The strip 219 is inwardly displaced relative to the horizontal outer contour of the container cover 205 and expediently designed so that the strip 219 can be introduced into the particle collecting container 202; thus in particular from the inside rests on the container peripheral walls 33, 34, 35, 36 when the container cover 205 is positioned on the particle collecting container 202.

The container cover 205 has on its underside exemplarily cover feet 221, which have a cylindrical, in particular hollow cylindrical design. The cover feet 221 extend further downwards than the strip 219, so that the container cover 205 can be positioned with the feet 221 on an underlying surface. The cover feet 221 are exemplarily arranged in the four corners of the rectangular underside of the cover indentation 105.

Expediently a plurality of particle collecting containers 202 with container covers 205, in particular sixteen particle collecting containers 202, can be arranged on a transport pallet 109, as already described in connection with FIG. 6.

By reference to FIGS. 17 and 18 in the following a cyclone pre-separator 201 shall be described which is designed to be positioned on the particle collecting container 202. The cyclone pre-separator 201 can expediently also be provided without a particle collecting container.

The cyclone pre-separator 201 represents a preferred further development of the cyclone pre-separator 1 explained above and shown in FIGS. 7, 8 and 9

The cyclone pre-separator 201 is—apart from the differences described below—designed like the cyclone pre-separator 1. The above descriptions relating to the cyclone pre-separator 1 insofar also apply to the cyclone pre-separator 201.

Like the cyclone pre-separator 1, the cyclone pre-separator 201 is designed to be positioned on a particle collecting container, here the particle collecting container 202. The cyclone pre-separator 201 comprises a box-shaped housing 3 and a cyclone unit (not shown) arranged in the housing 3. The housing 3 has an air inlet 5 and an air outlet 6, and lower housing couplers 11, designed to provide a releasable, vertically tension-proof coupling with the particle collecting container 202 when the cyclone pre-separator 201 is positioned on the particle collecting container 202. Exemplarily the lower housing couplers 11 comprise two movably mounted locking elements. The housing 3 has on the underside 7 a particle outlet 8, which is exemplarily circular.

Unlike the cyclone pre-separator 1 the cyclone pre-separator 201 has on each of its two longitudinal peripheral walls 18, 19 a recess 231 which exemplarily extends as far as the underside 7.

The recesses 231 are each centrally arranged in the longitudinal direction. The recesses 231 are further designed to correspond with the container recesses 211. The recesses 231 are expediently similarly formed by angled (in relation to the longitudinal direction) transition wall portions 232 and a central wall portion 233 positioned between them in the longitudinal direction, the central wall portion 233 running parallel to the longitudinal direction. The central wall portion 233 is inwardly displaced in relation to the outer wall portions 234. The recess 231 is positioned in the longitudinal direction between two outer wall portions 234.

The lower housing couplers 11 are expediently arranged in the recesses 231.

The cyclone pre-separator 201 has on its underside 7 a groove 25, running along the outer edge 26 of the underside 7 and designed to accept the upper edge 27 of the particle collecting container 202. The groove 25 has a recess on each of its longitudinal sides designed to correspond with the container recesses 211.

FIG. 19 shows an assembly of the cyclone pre-separator 201, the particle collecting container 202 and an adapter frame 251. The cyclone pre-separator 201 is positioned on the particle collecting container 202 and the particle collecting container 202 is inserted in a container receptacle 43 of the adapter frame 251. Expediently the assembly can also be provided without the adapter frame 251, and the particle collecting container 202 can then rest on a flat underlying surface; i.e. the container bottom 31 is designed so that the assembly (without adapter frame 251) can be positioned on a flat surface in a stable manner with the container bottom 31. Expediently the relationship between the cyclone pre-separator 201 and the particle collecting container 202 is as already described in connection with FIG. 7. The particle collecting container 202 and the cyclone pre-separator 201 can also be used together with the suction device 41, as described above in connection with FIG. 9. In particular the adapter frame 251 can be used here as the adapter frame.

FIG. 20 shows the adapter frame 251, provided here without particle collecting container.

The adapter frame 251 represents a preferred further development of the adapter frame 251 explained above and shown in FIGS. 7, 8 and 9.

The adapter frame 251 is—apart from the differences explained below—designed like the adapter frame 51. The above explanations relating to the adapter frame 51 insofar also apply to the adapter frame 251.

The adapter frame 251 is used for mounting onto a base, in particular onto a suction apparatus 79, a system box and/or a roller board. The adapter frame 251 is further used to receive a particle collecting container 202 for a cyclone pre-separator 201, wherein the adapter frame 251 comprises a rectangular underside and adapter frame peripheral walls 83, 84, 85, 86 extending upwards from the underside, and lower adapter frame couplers 53, designed to provide a releasable, vertically tension proof coupling to the base when the adapter frame 251 is positioned on the base, and wherein the adapter frame 251 on its upper side 114 has a container receptacle 43 for receiving the particle collecting container 202, the horizontal inner contour of which tapers towards the underside, so that the container receptacle 43 is able to receive a particle collecting container 202 with an outer contour tapering downwards and to stabilise the particle collecting container 202 horizontally.

Exemplarily the length of the underside of the adapter frame 251 is between 350 mm and 450 mm and the width of the underside of the adapter frame 251 is between 250 mm and 350 mm. Preferably the height of the adapter frame 51 is at least a quarter of the length of the underside 115, in particular at least 100 mm. Preferably the inner contour of the container receptacle 43 tapers continuously over the vertical extension of the container receptacle 43.

Expediently the container receptacle 43 on its upper side 114 accounts for at least 60% of the base area of the adapter frame 251. Exemplarily all inner sides of the container receptacle 43 contribute to the taper.

Exemplarily the adapter frame 51 has an edge 252 protruding vertically upwards over the container receptacle 43, which surrounds the container receptacle 43 and which at least in sections is displaced horizontally inwards in relation to the outer contour of the adapter frame. The edge 252 is in particular displaced horizontally inwards in the region of the frontal adapter frame peripheral walls 85, 86 and/or in the region of the recesses 253 explained further in the following in relation to the outer contour of the underside. Expediently the upper edge 252 runs in correspondence, in particular identically to the upper edge 27 of the particle collecting container 202.

Unlike the adapter frame 51 the adapter fame 251 has a recess 253 on each of its longitudinal adapter frame peripheral walls 83, 84.

Each recess 253 is expediently located in the longitudinal direction x centrally on the respective adapter frame peripheral wall 83, 84. Each recess 253 extends expediently upwards as far as the upper side 114 and is also present on the upper side 114.

Exemplarily each longitudinal adapter frame peripheral wall 83, 84 has two outer wall portions 256 and a central wall portion 255, arranged in the longitudinal direction x between the two outer wall portions 256. The central wall portion 255 is inwardly displaced in relation to the outer wall portions 256 in the y-direction thereby forming the recess 253. The transition from the outer wall portions 256 to the central wall portion 255 is formed by the transition portions 254 which are located in the longitudinal direction between the central wall portion 255 and each of the outer wall portions 256. The transition portions 254 run expediently in y-x-directions, in particular in directions which relative to the longitudinal direction are rotated about a vertical axis by ±20 to ±50 degrees, in particular ±30 to ±40 degrees. The outer wall portions 256 and/or the central wall portion 255 run exemplarily in the x direction. The recess 253 is formed by a central wall portion 255 and two transition wall portions 254.

Exemplarily the adapter frame 251 has upper adapter frame couplers 52, designed to provide a releasable, vertically tension-proof coupling with the cyclone pre-separator 251, when the cyclone pre-separator 201 is positioned on the adapter frame 251. The upper adapter frame couplers 52 can expediently be coupled to the lower housing couplers 11, to create the tension-proof coupling. The upper adapter frame couplers 52 are in particular designed to correspond to the container couplers 37.

The upper adapter frame couplers 52 are expediently arranged on the longitudinal adapter frame peripheral walls 83, 84, in particular in the recesses 253.

The upper adapter frame couplers 52 are in particular non-movable adapter frame couplers, expediently bar-shaped projections, in particular precisely two bar-shaped projections. The adapter frame couplers 52 have a longitudinal basic shape and are preferably aligned with their longitudinal axis parallel to the longitudinal direction and in the longitudinal direction in particular centrally arranged on the longitudinal adapter frame peripheral walls 83, 84. Expediently the container adapter frame couplers 52 each run from one transition wall portion 254 to another transition wall portion 254.

The inner sides of the container receptacle 43 are formed by longitudinal receptacle walls 273, 274 and transversal receptacle walls 275, 276. The longitudinal and transversal receptacle walls 273, 274, 275, 276 together define the inner contour of the container receptacle 43. The container receptacle 43 also has a receptacle bottom 277, which is expediently formed by a honeycomb structure.

On each longitudinal receptacle wall 273, 274 expediently an inward protrusion 263 is present. The protrusion 263 are designed to correspond to the container recesses 211, so that the protrusions 263 each engage in the container recesses 211, when the particle receiving container 202 is positioned in the container receptacle 43, as shown in FIG. 19.

Each protrusion 263 is expediently located in the longitudinal direction x centrally on the respective receptacle wall 273, 274 and preferably extends in the transversal direction y towards the inside of the container receptacle 43. Each protrusion 263 extends expediently over the entire vertical extension of the particle container receptacle 43.

Exemplarily each longitudinal receptacle wall 273, 274 has two outer wall portions 266 and one central wall portion 265, arranged in the longitudinal direction x between the two outer wall portions 266. The central wall portion 265 is inwardly displaced in relation co the outer wall portions 266 in the y-direction thereby forming the protrusion 263. The transition from the outer wall portions 266 to the central wall portion 265 is formed by the transition portions 264 which are located in the longitudinal direction between the central wall portion 265 and each of the outer wall portions 266. The transition portions 264 run expediently in y-x-directions, in particular in directions which relative to the longitudinal direction are rotated about a vertical axis by ±20 to ±50 degrees, in particular ±30 to ±40 degrees. The outer wall portions 266 and/or the central wall portion 265 run exemplarily in the x direction. A protrusion 263 is formed by a central wall portion 265 and two transition wall portions 264.

FIG. 21 shows an assembly comprising an adapter frame 251 and a box-shaped cyclone pre-separator 251 positioned on the adapter frame 201, wherein the adapter frame 251 has upper adapter frame couplers 52 and the cyclone pre-separator 201 has lower housing couplers 11 and wherein the upper adapter frame couplers 51 and the lower housing couplers 11 provide a releasable, vertically tension-proof coupling between the adapter frame 251 and the cyclone pre-separator 201.

The cyclone pre-separator 201 can selectively be positioned on the particle collecting container 202 or on the adapter frame 251 and coupled vertically in a tension-proof manner.

Expediently the adapter frame 251 further has lower adapter frame couplers 53 and the cyclone pre-separator 201 has upper housing couplers 12, wherein the lower adapter frame couplers 53 and the upper housing couplers 12 are designed to provide a releasable, vertically tension-proof coupling between the adapter frame 251 and the cyclone pre-separator 201 when the adapter frame 251 is positioned on the cyclone pre-separator 201.

1-16. (canceled)

17. A particle collecting container that is designed as a stand structure for a cyclone pre-separator, which particle collecting container is able to be positioned on a flat underlying surface in a stable manner and has an open upper surface, on which the cyclone pre-separator is able to be placed, the particle collecting container comprising:
a rectangular container bottom and four container peripheral walls, which extend upwards from the container bottom and define a horizontal outer contour of the particle collecting container,
wherein the horizontal outer contour defined by the container peripheral walls tapers towards the container bottom and the particle collecting container can be stacked into an identical particle collecting container.

18. The particle collecting container according to claim 17, wherein on each of the longitudinal container peripheral walls a recess is present, which extends over the entire vertical extension of the particle collecting container.

19. The particle collecting container according to claim 18, wherein the particle collecting container has container couplers, arranged in the recesses and designed to provide a releasable, vertically tension-proof coupling between the particle collecting container and the cyclone pre-separator, when the cyclone pre-separator is positioned on the particle collecting container.

20. The particle collecting container according to claim 17, wherein the wall planes of the four container peripheral walls are inclined away from the normal vector of the container bottom so that container peripheral walls together make the shape of an inverted truncated pyramid periphery.

21. The particle collecting container according to claim 17, wherein the container peripheral walls have a top edge on which a surrounding seal is arranged.

22. The particle collecting container according to claim 17, wherein the particle collecting container has on two opposing container peripheral walls container handles.

23. The particle collecting container according to claims 22, wherein the container handles are designed as spacers which when the particle collecting container is stacked in an identical particle collecting container, ensure a specified vertical distance between the two upper surfaces of the inter-stacked particle collecting containers.

24. The particle collecting container according to claim 22, wherein the container handles have horizontal bars and vertical bars and are designed so that when the particle collecting container is stacked in an identical particle collecting container, lower edges of the vertical bars rest on the upper surface of the identical particle collecting container thereby ensuring the specified vertical distance.

25. The particle collecting container according to claim 22, further comprising a bow-shaped carrying handle, mounted on the container handles.

26. The particle collecting container according to claim 17, further comprising a container cover positioned on the open upper side, wherein on the upper side of the container cover an indentation is provided, designed to correspond with the container bottom of the particle collecting container so that an identical particle collecting container can be stacked on the container cover in a stable manner.

27. The particle collecting container according to claim 25, wherein the length of the container cover is between 390 mm and 400 mm and the width of the container cover is between 290 min and 300 mm.

28. The particle collecting container according to claim 17, wherein the particle collecting container is produced by injection moulding.

29. A stack, comprising a particle collecting container according to claim 17 and an additional particle collecting container with a design identical to the particle collecting container, wherein the particle collecting container is stacked in the additional particle collecting container.

30. An arrangement, comprising a transport pallet and sixteen particle collecting containers according to claim 17 arranged thereon, distributed over two stack levels, wherein each stack level has two rows each with four particle collecting containers, and wherein each stack level accounts for more than 90% of the base area of the transport pallet.

31. A method for disposing of particles that can be sucked up, comprising the steps of: sucking up the particles using a cyclone pre-separator into a particle collecting container according to claim 17, and closing the particle collecting container, further comprising the step of: taking the particles to final disposal in the particle collecting container.

32. A method for sucking up particles, comprising the steps of: sucking up particles into a particle collecting container according to claim 17, using a cyclone pre-separator positioned on the particle collecting container, removing the cyclone pre-separator from the particle collecting container, placing the cyclone pre-separator on an additional particle collecting container and sucking up particles into the additional particle collecting container using the cyclone pre-separator.

33. The method according to claim 31, wherein the final disposal includes incineration, final storage and/or recycling.
